(19) United States
(12) Patent Application Publication
(10) Pub. No.: US 2025/0369598 A1
(43) Pub. Date: Dec. 4, 2025

(54) CENTERPLATE FOR LIGHTING ASSEMBLIES

(71) Applicant: ERICO International Corporation, Solon, OH (US)

(72) Inventor: Michael Hung Sun Oh, Twinsburg, OH (US)

(21) Appl. No.: 19/222,266

(22) Filed: May 29, 2025

Related U.S. Application Data
(60) Provisional application No. 63/655,172, filed on Jun. 3, 2024.

(51) Int. Cl. F21V 21/03; F21S 8/04

(52) U.S. Cl. CPC F21V 21/03; F21S 8/043

(57) ABSTRACT

A centerplate for a lighting assembly may include a plurality of rings that are selectively removable to define different size openings for the lighting assembly. A first ring of the plurality of rings may define a first inner radius. A second ring of the plurality of rings may define a second inner radius that can be greater than the first inner radius, with a notch extending radially outwardly into the second ring to receive a cutting tool. A stem may extend from a connection with the first ring at the first radius to a cuttable portion of the stem within the notch, to connect the first ring to the second ring.

### CROSS-REFERENCE TO RELATED APPLICATIONS

This application claims priority under 35 U.S.C. 119 from U.S. Provisional Application No. 63/655,172, filed Jun. 3, 2024, titled “Centerplate For Lighting Assemblies,” which is incorporated herein by reference in its entirety.

### BACKGROUND

In some contexts, it may be useful to support electrical boxes, luminaires, lighting assemblies, or other objects relative to building structures.

### SUMMARY

Embodiments of the invention can provide an improved centerplate for receiving and mounting a lighting assembly. The centerplate may include a support portion and a plurality of rings. The plurality of rings can be integrally formed with the support portion. Each ring of the plurality of rings may be selectively removable to define a respective different size of opening in the support portion to receive the lighting assembly. The plurality of rings may include a first ring that defines a first inner radius corresponding to a first size of opening in the support portion, and may further include a second ring that defines a second inner radius corresponding to a second size of opening in the support portion. The second inner radius can be larger than the first inner radius. The second ring may include a notch that extends radially outward to define a notch inner radius on the second ring that is greater than the second inner radius. A stem may extend between the first ring and the second ring to connect the first ring to the second ring. The stem can have a minimum stem width within the notch, as measured perpendicularly to a radial direction along the stem, that defines a cutting location within the notch to separate the first ring from the centerplate.

Embodiments of the invention can provide an improved centerplate for receiving and mounting a lighting assembly. The centerplate may include a plurality of rings that are selectively removable to define different size openings for the lighting assembly. A first ring of the plurality of rings can define a first inner radius. A second ring of the plurality of rings may define a second inner radius that is greater than the first inner radius, with a notch extending radially outwardly into the second ring to receive a cutting tool. A stem may extend from a connection with the first ring at the first radius to a cuttable portion of the stem within the notch, to connect the first ring to the second ring.

Embodiments of the invention can provide a method for installing a lighting assembly onto a centerplate. The method may include providing a centerplate including a plurality of rings that are selectively removable to define different size openings for the lighting assembly, including a first ring that defines a first inner radius and a second ring that defines a second inner radius and is connected to the first ring by a stem. The method can include selectively removing the first ring from the centerplate by inserting a cutting tool into a notch that extends radially outwardly into the second ring, and cutting a cuttable portion of the stem within the notch.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a support assembly according to an embodiment of the invention;

FIG. 2 is an axonometric view of an example centerplate of the support assembly of FIG. 1;

FIG. 3A is a front elevation view of the centerplate of FIG. 2;

FIG. 3B is an enlarged view of portion IIIB of FIG. 3A;

FIG. 4 is a front elevation view of the centerplate of FIG. 2, with one or more rings removed;

FIG. 5A is a front elevation view of the centerplate of FIG. 4, including a lighting assembly installed within an opening defined by the rings;

FIG. 5B is an enlarged view of portion VB of FIG. 5A;

FIG. 6 is a rear elevation view of the centerplate of FIG. 2;

FIG. 7 is a side elevation view of the centerplate of FIG. 2;

FIG. 8 is an axonometric view of an example centerplate of the support assembly of FIG. 1;

FIG. 9 is a front elevation view of the centerplate of FIG. 8;

FIG. 10 is a front elevation view of the centerplate of FIG. 8, with one or more rings removed;

FIG. 11 is a rear elevation view of the centerplate of FIG. 8;

FIG. 12 is a side elevation view of the centerplate of FIG. 8;

FIG. 13 is an axonometric view of a support assembly according to an embodiment of the invention;

FIG. 14 is an axonometric view of an example centerplate of the support assembly of FIG. 13;

FIG. 15A is a front elevation view of the centerplate of FIG. 14;

FIG. 15B is an enlarged view of portion XVB of FIG. 15A;

FIG. 16 is a front elevation view of the centerplate of FIG. 14, with one or more rings removed;

FIG. 17A is a front elevation view of the centerplate of FIG. 16, including a lighting assembly installed within an opening defined by the rings;

FIG. 17B is an enlarged view of portion XVIIB of FIG. 17A;

FIG. 18 is a rear elevation view of the centerplate of FIG. 14; and

FIG. 19 is a side elevation view of the centerplate of FIG. 14.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The discussion herein is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In some installations, building codes or other considerations may require that lighting assemblies, electrical boxes, or other components be supported above a floor. In some cases, support brackets can be used to support lighting assemblies or other components between building structures (e.g., from a ceiling structure, specifically between tees of a hard lid ceiling or T-grid ceiling). Some conventional support brackets for supporting lighting assemblies from ceiling structures include monolithic sheet plates. These sheet plate support brackets are generally large, unwieldly, and can be prone to flex, bend, or otherwise perform adversely while supporting lighting assemblies. As such, sheet plate support brackets are often difficult to install, especially in overhead ceiling applications.

Some support brackets for lighting assemblies can generally include a plurality of concentric rings that are selectively removable. Each of the removable rings can define a different radius to allow the support bracket to mount and receive lighting assemblies of various sizes. In many examples, the rings of conventional support brackets are joined by connections that must be cut to remove one or more of the rings. However, cutting the connections that join the removable rings can result in jagged protrusions that extend toward a center of the rings. The jagged protrusions can interfere with the mounting of a lighting assembly to the bracket, and can potentially cause damage to the lighting assembly (or otherwise) during assembly.

Some support brackets for lighting assemblies generally require installers to fasten lighting assemblies to the support brackets using screws. However, in many examples, the installers may be required to punch a hole through the support bracket using a drill gun or other machinery to secure the screw, and the lighting assembly, to the support bracket. Securing lighting assemblies to conventional support brackets can therefore be laborious and time-consuming.

Embodiments of the disclosed invention may address these and other issues, including by providing an improved centerplate for receiving and mounting lighting assemblies. In some examples, the centerplates described herein can mitigate potential flexing or other adverse responses of the support brackets to loading, by utilizing stamped embossments or otherwise rigidly reinforced components. In some examples, the centerplate described below can include a plurality of rings for receiving a lighting assembly that may be shaped to mitigate the formation of interfering protrusions during removal of one or more of the rings to accommodate a lighting assembly of a particular size. Specifically, removal of the rings is designed to provide a cleaner opening for the installation of various sizes of lighting assemblies.

In some embodiments, a centerplate for supporting equipment (e.g., lighting assemblies) from a building support structure (e.g., from a ceiling structure) can include a plurality of rings that are selectively removable to receive and mount equipment to the centerplate. Some examples in particular can be configured for use with hard lid ceilings or T-grid ceilings, although other configurations are possible. Each of the plurality of rings can define a different radius, allowing the centerplate to receive and mount equipment of various sizes, depending on which of the ring(s) is removed or not. The rings may be disposed concentrically around a center point, and may be connected by one or more stems. Cutting the stems that connect adjacent rings (e.g., a first ring and a second ring defining a larger radius than the first ring) may allow a worker to remove the first ring from the centerplate and install a lighting assembly in the resulting opening.

In some embodiments, the rings are designed with notches that align with the stems that interconnect the rings. This alignment can simplify the process of cutting the stems and to minimize the possibility of creating interfering protrusions when cutting the stems. For example, the notches can act as predetermined cutting guides that are recessed from a main radius of a corresponding opening. Thus, when the stems are severed, the resulting edges are less likely to protrude into the space intended for the lighting assembly, thereby facilitating a smoother installation process. For example, a first stem connecting adjacent rings can extend from an outer radius of a first (inner) ring and connect with a second (outer) ring in a notch disposed in the second ring. The notch can provide easy access to the first stem for a blade, pliers, or other known cutting tool. Further, the notch can provide a cutting location for the stem that is recessed relative to a main diameter of the second ring within which a lighting assembly (or other equipment) can be received. Correspondingly, any protrusion resulting from cutting the first stem can be contained within the notch, helping to ensure that the protrusion does not interfere with a lighting assembly received by the second ring.

In some embodiments, the lighting assembly installed within the centerplate can be further secured to the centerplate using one or more fasteners. The fasteners (e.g., screws) can extend through a component of the lighting assembly and through the centerplate to secure the lighting assembly to the centerplate. More specifically, a gap can be formed between each set of adjacent concentric rings (e.g., between the second ring and a third ring defining a larger radius than the second ring) that is configured to receive the fasteners to secure the lighting assembly to the centerplate. In some embodiments, using the gaps between adjacent concentric rings to receive the fasteners may reduce installation time and effort, by providing pre-formed locations for fastener insertion, mitigating the need for installers to drill holes in the centerplate during the installation process.

In some embodiments, the fasteners used to secure the lighting assembly to the centerplate may be positioned within the gap adjacent to the ring retaining the lighting assembly. More specifically, the fasteners may be inserted into the gap defined between the ring retaining the lighting assembly and the ring having the next largest diameter. For example, if the lighting assembly is retained within the second ring, the fasteners can extend through the gap formed between the second ring and the third ring.

In some embodiments, one or more rings of the concentric rings may not be removable. More specifically, a non-removable ring can be positioned between the outermost removable concentric ring and a perimeter of the concentric circles, and an outermost gap can be formed between the non-removable ring and the perimeter of the concentric circles. The outermost gap can therefore always be present on the centerplate, providing a permanent gap for receiving the fasteners even when each of the removable concentric rings are removed.

In some embodiments, a perimeter of the rings can be extruded. Extruding the perimeter of the rings can increase a rigidity of the centerplate and reduce flexing and bending of the centerplate during and after installation.

In some embodiments, the centerplate can be asymmetric. Specifically, the plurality of rings can be arranged asymmetrically on the centerplate. For example, a center of the plurality of rings of a knockout of the centerplate can be offset relative to a centerline of the centerplate. In some applications, utilizing the centerplate having such an offset knockout can allow a lighting assembly that is supported between a first and second ceiling structure to be positioned adjacent to one of the first or second ceiling structures (e.g., for aesthetic or other purposes). Additionally, an asymmetric centerplate can mount a lighting device (e.g., light bulb, or other light emitting device) through the knockout on a first side of the centerline and mount the electrical box and other components of the lighting assembly on a second side of the centerline opposite the first side, reducing a footprint of the centerplate by maximizing the usable space of the centerplate.

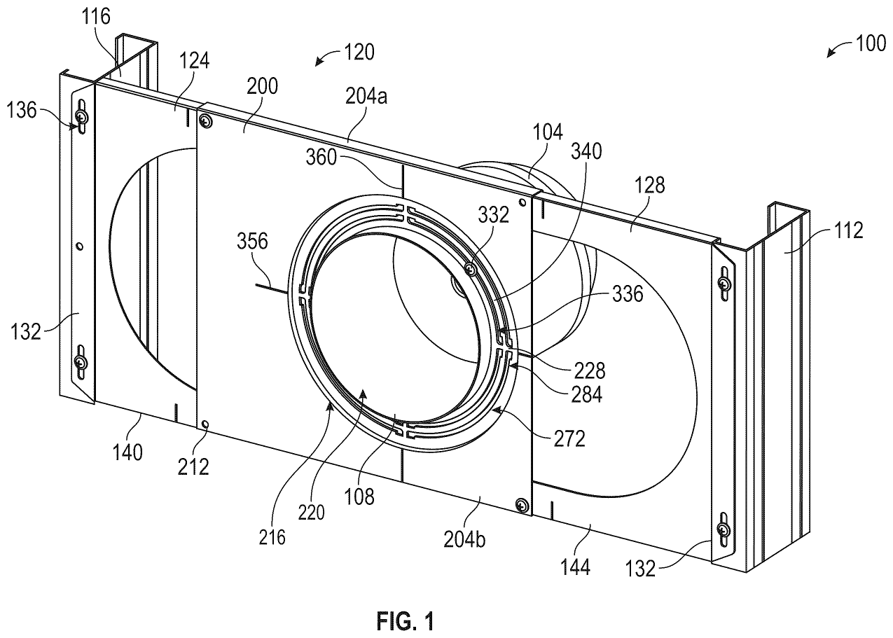

FIGS. 1-3 illustrate an example support assembly 100 configured to support various equipment 108 (e.g., a lighting assembly, as shown, or other electrical assemblies) between a first and second building structure 112, 116 (e.g., a stud or tee of a T-grid ceiling or a hard lid ceiling assembly). The support assembly 100 can include a centerplate 200 configured to receive and retain the equipment 108. Additionally, the support assembly 100 can include a telescopically adjustable bracket 120, having a first bracket member 124 and a second bracket member 128, configured to support the centerplate 200 relative to building structures. In some examples, the first bracket member 124 and the second bracket member 128 can be adjusted relative to the centerplate 200 to adjust an extension length of the support assembly 100, allowing the support assembly 100 to be secured between first and second building structures 112, 116 (e.g., studs, as shown) that are spaced apart by various distances.

Referring to FIG. 1, the centerplate 200 can include a plurality of centerplate rail members (e.g., a first plurality of rail members). Specifically, the centerplate 200 may include a first centerplate rail 204a and a second centerplate rail 204b. The centerplate rails 204a, 204b may extend substantially parallel with one another along opposite edges of the centerplate 200. In some embodiments, the centerplate 200 can be rectangular in shape, and the centerplate rails 204a, 204b may extend along the longest edges of the centerplate 200. As will be described below, the centerplate rails 204a, 204b may slidably nest rails of the telescopically adjustable bracket 120 to provide telescopic adjustability to the support assembly 100.

Still referring to FIG. 1, as described above, the telescopically adjustable bracket 120 includes the first bracket member 124 and the second bracket member 128 configured to be secured to the first and second building structures 112, 116. In different arrangements, different features can be provided on a bracket to secure the bracket to building structures. The first and second bracket members 124, 128 can each include a mounting flange 132 with one or more mounting openings 136. As illustrated in FIG. 1, when mounting the support assembly 100 between the building structures 112, 116, fasteners (e.g., screws or other known fasteners) may fasten one or more of the four corners of the telescopically adjustable bracket 120 to the building structures 112, 116. In other contexts, it may be advantageous to utilize only two fasteners, or to secure a centerplate relative to building structure in other ways.

In different examples, different types of telescoping or other arrangements (e.g., rail profiles) can be used. In the illustrated example, the bracket members 124, 128 can include a plurality of first bracket rails 140 and a plurality of second bracket rails 144, respectively. In some embodiments, the centerplate rails 204a, 204b can slidably nest with the first and second plurality of bracket rails 140, 144. This arrangement allows the first and second bracket members 124, 128 to be slidably adjusted relative to the centerplate 200, providing the ability to telescopically adjust an extension of the support assembly 100 to span a range of distances between the first building structure 112 and the second building structure 116. The first and second bracket members 124, 128 can be slidably adjusted relative to the centerplate 200 along an adjustment direction. As such, the centerplate rails 204a, 204b may extend along the centerplate 200 substantially parallel to the adjustment direction.

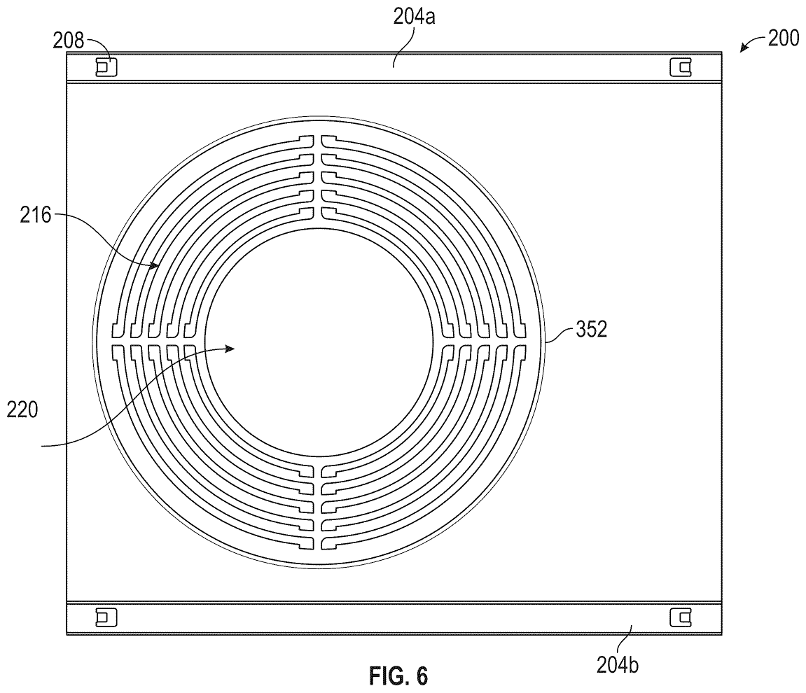

Referring briefly to FIG. 6, the centerplate rails 204a, 204b may include centerplate tabs 208 configured to contact the plurality of first and second bracket rails 140, 144 slidably nested with the centerplate rails 204a, 204b. The centerplate tabs 208 can be configured to provide mechanical resistance against telescopically adjusting the support assembly 100. Additionally, in some examples, the centerplate tabs 208 may engage protrusions, tabs, or other structures on the bracket members 124, 128 to prevent over-extension of the support assembly 100.

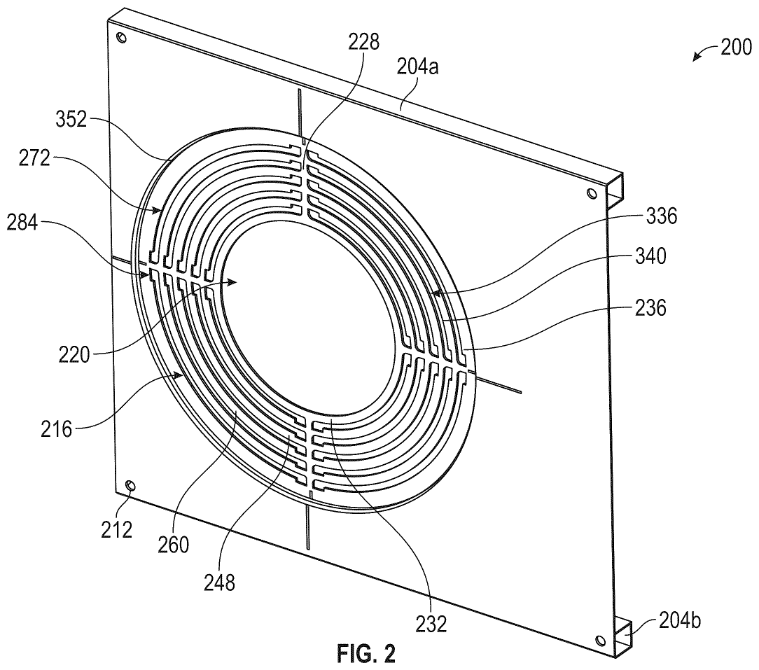

Referring again to FIGS. 1 and 2, in some embodiments, the centerplate 200 may include fastener apertures 212 configured to receive and retain fasteners (e.g., screws or other known fasteners, not shown) to couple the centerplate 200 to the bracket members 124, 128, and to fix a position of the centerplate 200 relative to the bracket members 124, 128 (or other structures). In some embodiments, a fastener extending through only one of the fastener apertures 212 to couple the centerplate 200 to one of the bracket members 124, 128 may be sufficient to stabilize the centerplate 200 relative to the bracket members 124, 128 and the building structures 112, 116.

Although the centerplate 200 is described as being supported by the telescopically adjustable bracket 120 using nested sliding rails, the centerplate 200 may also be included in other adjustable or non-adjustable assemblies. For example, in some embodiments the centerplate 200 may instead be directly secured to the first or second building structures 112, 116.

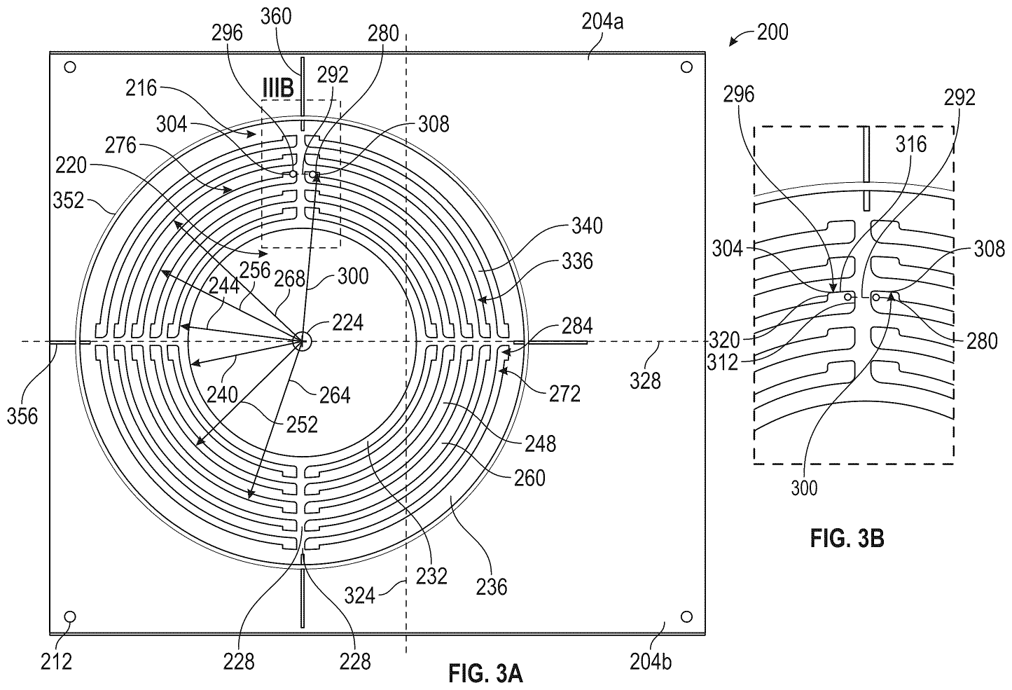

Referring to FIGS. 2-3B, the centerplate 200 includes a plurality of rings 216 that form an equipment opening 220 configured to receive and retain the equipment 104. In some embodiments, one or more of the plurality of rings 216 can be selectively removed (e.g., cut out) to enlarge the equipment opening 220, and allow the equipment opening 220 to receive and retain the equipment 108 of various diameters and sizes.

Referring to FIGS. 3A and 3B, the plurality of rings 216 may be disposed concentrically around a center point 224 of the plurality of rings 216 (see FIG. 3A), such that each of the plurality of rings 216 shares the center point 224. Furthermore, each of the rings 216 may be disposed circumferentially around the center point 224. Each of the rings 216 may define a unique inner radius, corresponding to typical radii of standard lighting assemblies, and a unique outer radius that is larger than the inner radius. For example, the centerplate 200 may include the rings 216 having an inner radius of about 2.18″, 2.49″, 2.83″, 3.17″, 3.51″, or 3.85″. As illustrated in FIG. 3A, the plurality of rings 216 may include five removable rings and a non-removable perimeter (e.g., outer-most) ring. However, the centerplate 200 may include more or fewer rings having any radius to mount and receive equipment of any size.

To allow for easy removability, the plurality of rings 216 may be connected and supported by a plurality of stems 228. Specifically, successive rings (e.g., an inner ring and an outer ring) of the plurality of rings 216 can be connected by one or more of the stems 228 extending from an outer diameter of the inner ring to an inner diameter of the outer ring. In some examples, the stems 228 may extend between the outer diameter of the inner ring to the inner diameter of the outer ring in a radial direction that is radial relative to the center point 224. However, in other examples, the stems 228 may extend between the outer diameter of the inner ring to the inner diameter of the outer ring in a direction that is oblique relative to the radial direction.

In some examples, the stems 228 may be equally spaced around the successive rings 216 to provide balanced support to the rings 216. For example, as illustrated in FIG. 3A, four of the stems 228 may connect the successive rings 216 at a 90-degree interval. However, in some embodiments, more or fewer of the stems may be positioned at any interval around the rings 216. As described further below, one or more of the plurality of rings 216 may be removed by selectively cutting the stems 228 between the successive rings 216.

Still referring to FIG. 3A, the rings 216 may include a first ring 232 (e.g., an inner-most ring) and a perimeter ring 236 (e.g., an outermost ring). In some examples, one or more of the stems 228 connecting each of the rings 216 between the first ring 232 and the perimeter ring 236, inclusive, may be aligned along a radius of the perimeter ring 236 extending from the center point 224 of the plurality of rings 216. However, in other examples, the stems 228 connecting the rings 216 are not aligned along a radius of the perimeter ring 236.

As described above, each of the plurality of rings 216 may define a unique radius measured along a radial direction that extends radially from the center point 224. Specifically, each of the plurality of rings 216 may define a unique inner radius and outer radius. As illustrated in

FIG. 3A, the first ring 232 may define a first inner radius 240 and a first outer radius 244, a second ring 248 may define a second inner radius 252 and a second outer radius 256, and a third ring 260 may define a third inner radius 264 and a third outer radius 268. Each successive outer radius may be larger than its corresponding inner radius. Furthermore, the third inner radius 264 may be larger than the second outer radius 256, and the second inner radius 252 may be larger than the first outer radius 244. As described above, the centerplate 200 can include more or fewer of the rings 216, each defining unique inner and outer radii. In some examples, one or more of the rings 216 may be disposed between the first, second, and third rings 232, 248, 260. Additionally, one or more of the rings 216 may define a larger inner radius than the third outer radius 268.

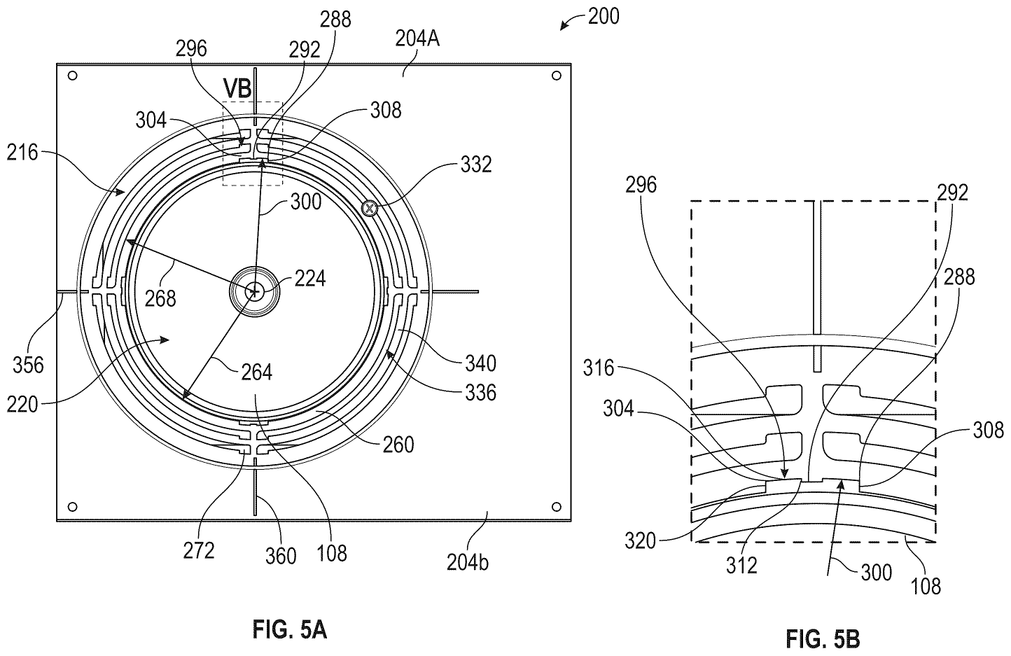

Still referring to FIGS. 3A and 3B, in some embodiments, gaps 272 may be disposed between each of the rings 216 (e.g., between an inner radius and an outer radius of successive rings). Similar to the rings 216, the gaps 272 may be annular, disposed concentrically around the center point 224. In some embodiments, a width of the gaps 272 between the rings 216 may be substantially equal along a line extending radially from the center point 224, however in other embodiments, the widths of the gaps 272 along a line extending radially from the center point 224 may vary. As described above, successive rings of the plurality of rings 216 may be connected by the stems 228. The stems 228 may span the gaps 272 between each of the rings 216, providing support to the rings 216 and to the equipment 104 received within the rings 216 (as shown in FIG. 5A). As described further below, in some examples, the gaps 272 may receive fasteners configured to secure a lighting assembly to the centerplate 200.

As described above, one or more of the rings 216 can be removed by selectively cutting the stems 228. For example, cutting the stems 228 at a first gap 276 between the third inner radius 264 of the third ring 260 and the second outer radius 256 of the second ring 248, may sever a connection of the second ring 248 to the centerplate 200. The second ring 248 may therefore be removed from the centerplate 200. Furthermore, during removal of the second ring 248 any other interior ring still connected to the second ring 248 (e.g., the first ring 232), may also be removed from the centerplate 200 along with the second ring 248.

In some embodiments, the stems 228 may be beneficially cut at a cut line 280 (e.g., at a cuttable portion of the stems 228) between a particular set of two successive rings of the rings 216. In some examples, the cut line 280 along the stems 228 can be positioned closer to an outer ring than to an inner ring of the particular set of two successive rings of the rings 216. More specifically, a distance between the cut line 280 and the outer ring is less than a distance between the cut line 280 and the inner ring of the particular set of two successive rings of the rings 216. As described further below, the cut lines 280 along each of the stems 228 may be disposed in notches 284 that increase access to the stems 228 for cutting tools.

In some examples, the cut line 280 can be along a width of the stems 228. For example, the cut line 280 can be substantially perpendicular to a radial direction extending radially from the center point 224. In some examples, the width of each of the stems 228 at the cut line 280 can be a minimum width of the respective stem 228 measured substantially perpendicular to the radial direction. As such, the cut line 280, or the cuttable portion of the stems 228, can be located at a narrowest portion of the stems 228. In some examples, the width of the stems 228 can vary between two successive rings of the rings 216. For example, the width of one or more of the stems 228 may decrease or taper between an inner ring and an outer ring of the two successive rings of the rings 216. In another example, the width of one or more of the stems 228 may decrease or taper between the inner ring and the cut line 280 along the stems 228. As such, and as described further below, the stems 228 may be advantageously cut near the outer ring of the two successive rings of the rings 216.

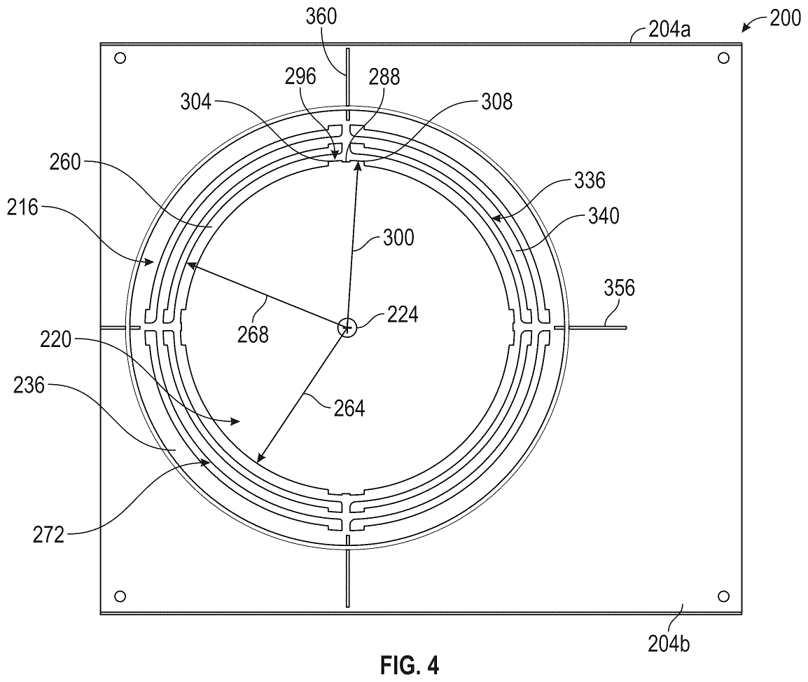

In some embodiments, to assist when a user severs the stems 228 between the rings 216, the rings 216 may include the notches 284 that act as predetermined cutting guides. More specifically, the stems 228 connecting an outer radius of an inner ring of the rings 216 to an inner radius of an outer ring of the rings 216 can be cut along the cut line 280 that is disposed within the notches 284. In some examples, the cut line 280 within the notches 284 can be radially farther from the center point 224 than the inner radius of the outer ring of the two successive rings of the rings 216. Accordingly, when the stems 228 are severed, the resulting edges or protrusions 288 of the severed stems 228 are less likely to protrude from the outer ring into the space of the opening 220 intended for the equipment 108. More specifically, as illustrated in FIGS. 4 and 5A, cutting the stems 228 at the cut line 280, or along the minimum width of the stems 228, within the notches 284 may ensure any of the protrusions 288 that may remain after the stems 228 are cut, are radially recessed within the notches 284, and therefore do not extend from the outer ring beyond an inner radius of the outer ring, and do not interfere with the equipment 108 received within the opening 220 defined by the outer ring (see FIGS. 5A and 5B).

As illustrated in FIGS. 3A and 3B, each of the rings 216 may include the notches 284 that may extend from an inner radius of the rings 216 toward an outer radius of the rings 216, to locally enlarge the gaps 272 adjacent the stems 228. The notches 284 may provide extra space to maneuver cutting tools between the rings 216. In some embodiments, one or more of the rings 216 may not include the notches 284. For example, as illustrated in FIGS. 3A and 3B, the first ring 232 may not include the notches 284. Furthermore, as described further below, another ring of the rings 216 may not include the notches 284.

In some examples, none of the rings 216 may include notches that extend from the outer radius of the rings 216 toward an inner radius of the rings 216. However, in other examples, one or more of the rings 216, may include notches that extend from the outer radius of the rings 216 toward an inner radius of the rings 216.

Referring specifically to FIG. 3B, a first stem 292 of the stems 228 may extend radially from the second ring 248 to the third ring 260. More specifically, the first stem 292 may span the first gap 276 to connect the third ring 260 and the second ring 248. In some examples, the first stem 292 may extend through a first notch 296 of the notches 284. The first notch 296 may extend from the third inner radius 264 toward the third outer radius 268 (e.g., radially relative to the center point 224). In some embodiments, the first notch 296 may extend from the third inner radius 264 to a first notch radius 300 that is larger than the third inner radius 264, and smaller than the third outer radius 268. In some examples, the first notch radius 300 may define a maximum radial distance between a perimeter of the first notch 296 and the center point 224. In some embodiments, the first notch 296 may extend from the third inner radius 264 to the first notch radius 300 along the first stem 292. As such, a maximum extension (e.g., radial extension) of the first notch 296 into the third ring 260 may be adjacent to the first stem 292 (e.g., on either side of the first stem 292).

In some examples, the first notch 296 may locally enlarge the first gap 276 near the first stem 292. For example, the first notch 296 may locally enlarge the first gap 276 in a radial direction and in a direction that is substantially perpendicular to the radial direction, providing extra space to maneuver cutting tools between the second ring 248 and the third ring 260. Specifically, the first notch 296 may allow a worker to cut the first stem 292 along the cut line 280 within the first notch 296 that is disposed radially farther from the center point 224 than the third inner radius 264.

As mentioned above, the first notch 296 may not extend from the outer radius of the rings 216 toward an inner radius of the rings 216. More specifically, as illustrated in FIG. 3B, the first notch 296 may not extend from the second outer radius 256 toward the second inner radius 252 of the second ring 248.

Referring still to FIG. 3B, the first notch 296 may be shaped to accommodate cutting tools (e.g., a blade, pliers, or other known cutting tool) for cutting the first stem 292. As described above, the first notch 296 may extend radially from the third inner radius 264 to the first notch radius 300 (e.g., a radius measured from the center point 224). The first notch 296 may be centered along the first stem 292, so that the first stem 292 divides the first notch 296 into a first notch portion 304 (e.g., a first notch gap) and a second notch portion 308 (e.g., a second notch gap). The first notch portion 304 and the second notch portion 308 may therefore each extend along or adjacent to the first stem 292 outward into the third ring 260. However, as described above, the first notch portion 304 and the second notch portion 308 may not extend inward into the second ring 248.

In some embodiments, the first and second notch portions 304, 308 may be substantially identical, mirrored about the first stem 292. Specifically, as will be described further below, the first and second notch portions 304, 308 may extend in opposite directions continuously and symmetrically from the first stem 292. However, in other embodiments, the first and second notch portions 304 and 308 may be dissimilar.

The first notch portion 304 may be defined by edges of the first stem 292 and the third ring 260. For example, a first edge 312 of the first notch portion 304 may extend along the first stem 292, from the third inner radius 264 to the first notch radius 300. In other examples, the first edge 312 may extend between the second outer radius 256 and the first notch radius 300. In some examples, the first edge 312 of the first notch portion 304 may extend along the radial direction. However, the first edge 312 may instead extend obliquely relative to the radial direction. In some examples, the first edge 312 may be substantially linear. However, in some examples, the first edge 312 may curve toward the second notch portion 308, such that the width of the first stem 292, measured substantially perpendicular to the radial direction, tapers between the second ring 248 and the third ring 260.

A second edge 316 of the first notch portion 304 may extend into the third ring 260 continuously from the first edge 312 at the first notch radius 300 (e.g., relative to a circle defined by the first notch radius 300 centered about the center point 224). Furthermore, the second edge 316 of the first notch portion 304 may extend from the first edge 312 to a third edge 320 of the first notch portion 304. As the second edge 316 extends from the first edge 312, the second edge 316 may be adjacent to the first stem 292.

In some examples, the second edge 316 of the first notch portion 304 may extend substantially perpendicularly from the first edge 312 (e.g., substantially perpendicular to the radial direction). However, the second edge 316 may instead extend obliquely from the first edge 312 relative to the radial direction.

In some examples, the second edge 316 may be a flattened edge. For example, the second edge 316 may extend substantially linearly from the first edge 312. In such examples, the second edge 316 may be substantially linear between the first edge 312 and the third edge 320. In other examples, the second edge 316 may extend from the first edge 312 along a perimeter of the circle defined by the first notch radius 300 centered about the center point 224.

In some examples, the third edge 320 may extend from the first notch radius 300 to the third inner radius 264. In some examples, the third edge 320 may extend substantially parallel to the first stem 292 (e.g., the first edge 312) from the second edge 316 to the third inner radius 264. However, in other examples, the third edge 320 may extend obliquely relative to the first edge 312, or may extend along the radial direction.

In some embodiments, a shape of the first notch portion 304 may be defined by a perimeter of the first notch portion 304 that extends continuously around the first, second, and third edges 312, 316, 320. For example, the first, second, and third edges 312, 316, 320 may define a physical perimeter of the first notch portion 304. The shape of the first notch portion 304 may further be defined by a non-physical edge extending between the first and third edges 312, 320 opposite the second edge 316. For example, the non-physical edge may extend substantially parallel to the second edge 316 between the first and third edges 312, 320. In some embodiments, the shape of the first notch portion 304 may be substantially rectangular. Specifically, the edges of the first notch portion 304 (e.g., the first, second, and third edges 312, 316, 320, as well as the non-physical edge) can be connected at angles ranging from 80 to 100 degrees, inclusive. However, in some embodiments, the first notch portion 304 may instead be shaped similar to any variety of shapes (e.g., square, triangular, trapezoidal, or any other shape). Additionally, as described above, the first and second notch portions 304, 308 may be substantially identical, mirrored about the first stem 292.

Referring to FIGS. 4-5B, the protrusion 288 that remains after the first stem 292 is cut along the cut line 280 within the first notch 296 (as shown in FIGS. 3A and 3B) may consequently be maintained within the first notch 296. Specifically, an entirety of the protrusion 288 that extends from the third ring 260 may be disposed radially outward of the third inner radius 264, potentially allowing for the insertion of the equipment 108 into the third inner radius 264 (e.g., the opening 220 defined by the third inner radius 264) without the protrusion 288 causing obstruction. As illustrated in FIGS. 5A and 5B, the protrusion 288 maintained within the first notch 296 does not contact the equipment received and retained by the third ring 260.

In some embodiments, each of the notches 284 may be shaped substantially identically to the first notch 296, to advantageously accommodate cutting tools (e.g., a blade, pliers, or other known cutting tool) to cut the stems 228. For example, each of the notches 284 may be aligned along one of the stems 228, extending adjacent to the stem 228 from an inner radius of the corresponding ring 216 to a corresponding notch radius (e.g., between the inner and outer radius of the corresponding ring 216) to locally enlarge the gaps 272 near the stems 228.

In some embodiments, the plurality of rings 216 may be arranged asymmetrically on the centerplate 200. The centerplate 200 may include a first centerline 324 that extends substantially perpendicular to the centerplate rails 204a, 204b or to the adjustment direction, through a center of the centerplate 200. Furthermore, the centerplate 200 may include a second centerline 328 that extends substantially parallel to the centerplate rails 204a, 204b or to the adjustment direction through the center of the centerplate 200. As such, the second centerline 328 may extend substantially perpendicular to the vertical centerline 324. In some examples, the center point 224 of the rings 216 may be offset relative to the center of the centerplate 200 (e.g., an intersection of the first and second centerlines 324, 328). For example, the center point 224 of the rings can be disposed along the second centerline 328 offset from the first centerline 324 along the adjustment direction. The centerplate 200 may therefore be asymmetric about the first centerline 324, and symmetric about the second centerline 328. As such, the center point 224 may be centered on the centerplate 200 along a direction perpendicular to the adjustment direction.

As illustrated in FIG. 1, the offset of the center point 224 may aid the accommodation of asymmetrical equipment. Specifically, in the illustrated example, the equipment 108 may include a light received by the rings 216, and an electrical box positioned adjacent the light (not shown, but positioned to the left from the perspective of FIG. 1). The asymmetrical centerplate 200 may mount and accommodate the electrical box and other components of the equipment 108 on a portion of the centerplate 200 that is opposite the first centerline 324 from the center point 224 of the rings 216. The asymmetrical centerplate 200 may therefore reduce a footprint of the centerplate 200 by maximizing the usable space of the centerplate 200.

The offset of the center point 224 may also allow the equipment 104 to be mounted closer to one of the building structures 112, 116 to provide a unique aesthetic appearance. For example, the asymmetrical centerplate 200 includes the center point 224, that is offset in a direction that is toward the building structure 112. The offset center point 224 may therefore position the plurality of rings 216 closer to the building structure 112. In some embodiments, the offset of the center point 224 may permit a center of a light extending through the rings 216 to be positioned less than 6 inches from the building structure 112, closer than the existing support brackets discussed above (e.g., by positioning the centerplate 200 to contact the mounting flange 132 secured to the building structure 112). Alternatively, as discussed above, the centerplate 200 may instead be secured directly to the building structure 112.

Referring to FIGS. 1 and 5A, in some embodiments, one or more fasteners may secure the secure the equipment 108 to the centerplate 200. For example, one or more fasteners 332 (e.g., screws or other applicable fasteners) may extend through the centerplate 200 and a component of the equipment 108 to fasten the equipment 108 to the centerplate 200. In some embodiments, the fasteners 332 may extend through the gaps 272 formed between adjacent rings of the plurality of rings 216. The gaps 272 may provide pre-formed locations for insertion of the fasteners 332, which may simplify the installation process and reduce installation time of the equipment 108 onto the centerplate 200.

In some embodiments, the fasteners 332 securing the equipment 108 to the centerplate 200 may be positioned within the gap 272 that is adjacent to the ring 216 retaining the equipment 108 (e.g., the gap 272 that is adjacent to the opening 220). However, in other examples, the fasteners 332 securing the equipment 108 to the centerplate 200 may be positioned within any of the gaps 272 disposed between the opening 220 and a perimeter of the of rings 216.

As an illustrative example and as illustrated in FIG. 5A, the equipment 108 may be received in the opening 220 formed within the third ring 260 (e.g., the opening 220 resultant from the removal of the second ring 248). The fasteners 332 securing the equipment 108 received in the third ring 260 to the center plate 200 may extend through a second gap 336 of the gaps 272 that is formed between the third ring 260 and a fourth ring 340 that defines a larger diameter than the third ring 260 (e.g., the next successive ring of the rings 216). However, in other examples, the fasteners 332 may instead extend through another gap of the gaps 272.

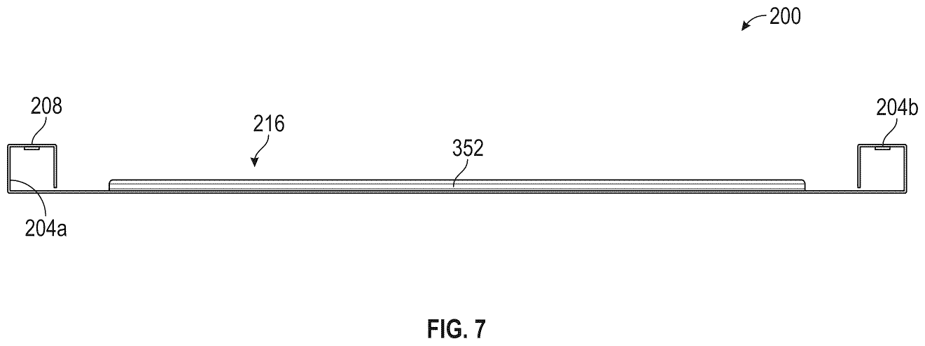

Referring to FIGS. 6 and 7, in some embodiments, a perimeter of the plurality of rings 216 (e.g., an outer diameter of the perimeter ring 236) may be extruded relative to the centerplate 200. More specifically, the perimeter of the plurality of rings 216 can be offset to define an embossment 352 or may be otherwise offset perpendicular to a plane of the surrounding material of the centerplate 200. The embossment 352 (or other similar offset) may reinforce the centerplate 200 by providing extra rigidity to mitigate flexion or bending of the centerplate 200 and the support assembly 100 during and after installation.

Referring again to FIGS. 3A and 3B, in some embodiments, the centerplate 200 can include alignment indentations that can aid the installation and the alignment of the support assembly 100. For example, the centerplate 200 may include a first set of alignment indentations 356 and a second set of alignment indentation 360. Each of the first and second sets of alignment indentations 356, 360 may include one or more linear indentations that can be stamped into the centerplate 200. Furthermore, each of the linear indentations of the first set of alignment indentations 356 can be aligned with one another (e.g., linearly), and each of the linear indentations of the second set of alignment indentations 360 can be aligned with one another (e.g., linearly). As described below, the first and second sets of alignment indentations 356, 360 may aid the visualization of the center point 224 of the rings 216 for the installers.

In some examples, a first set of alignment indentations 356 may extend along the second center line 328 of the centerplate 200 (e.g., along the adjustment direction), providing a visual representation of the second centerline 328 for installers. Furthermore, a second set of alignment indentations 360 may extend substantially perpendicular to the first set of alignment indentations 356 (e.g., parallel to the first centerline 324). In some examples, the second set of alignment indentations 360 may extend parallel to and be offset from the first centerline 324. In such examples, a first line drawn between the first set of alignment indentations 356 and a second set line drawn between the second set of aligned alignment indentations 360 may intersect at the center point 224 of the rings 216.

During installation, the installers may use laser alignment devices, or other applicable alignment devices, to align the centerplate 200 relative to the building structures 112, 116, relative to a layout of a room, or relative to other centerplates. The first and second sets of alignment indentations 356, 360 may advantageously aid the alignment process of the centerplate 200, by providing installers a readily visible marking on the centerplate 200 for visualizing alignment of the centerplate 200.

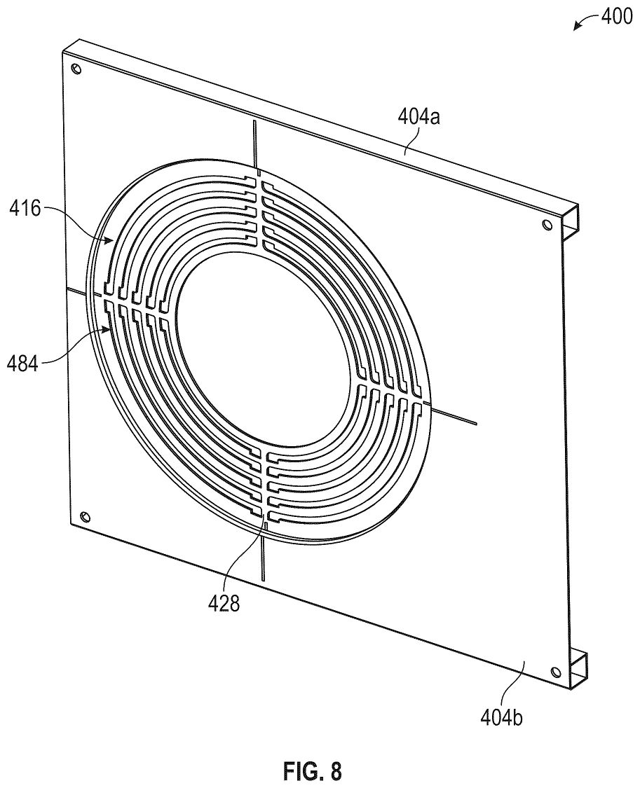

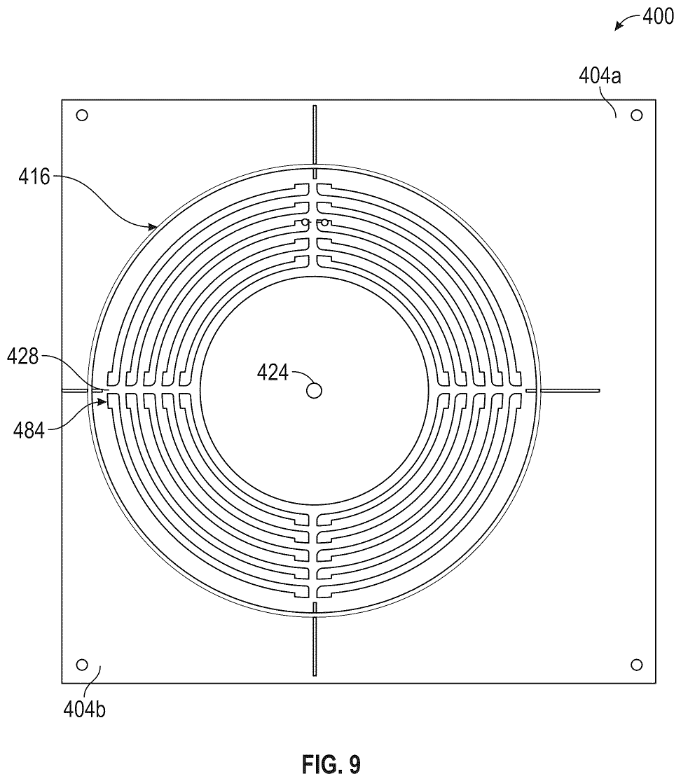

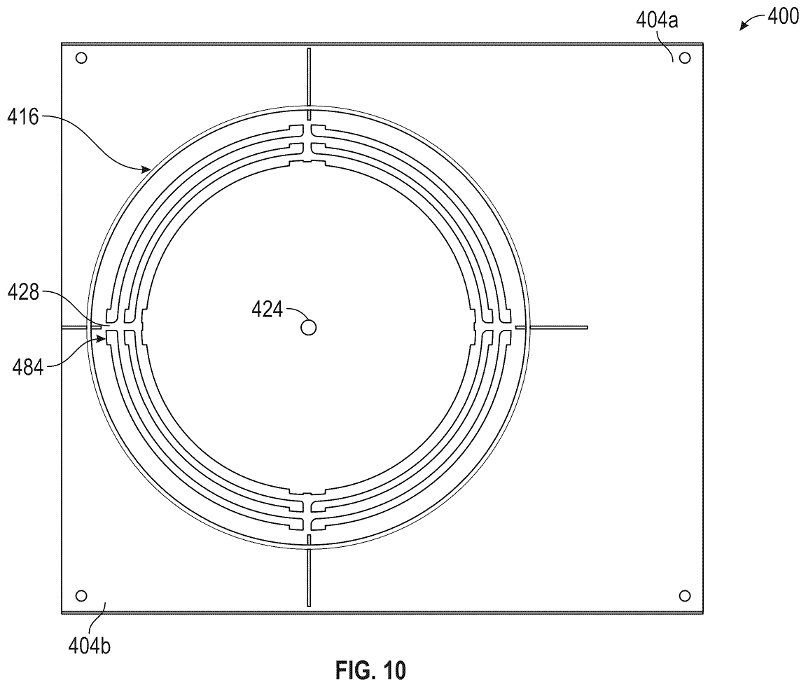

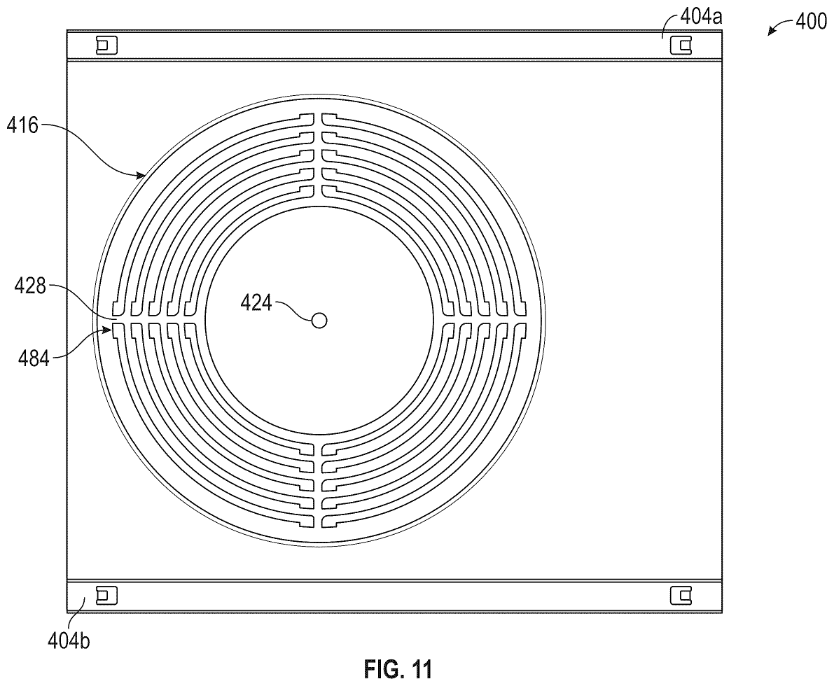

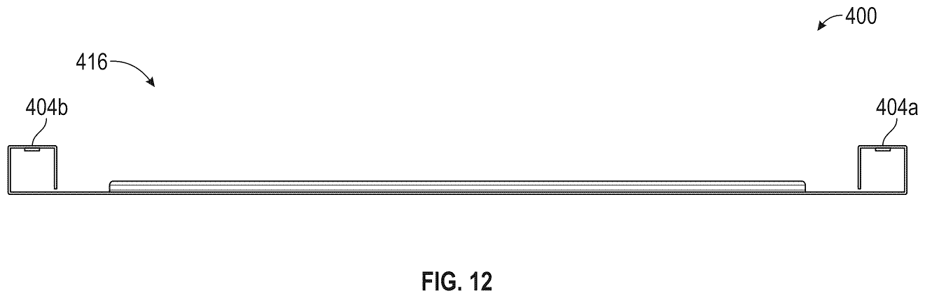

In some embodiments, a centerplate may be configured to support equipment between building structures that are positioned a shorter distance apart. In this regard, for example, FIGS. 8-12 illustrate another embodiment of a centerplate 400. The centerplate 400 of FIGS. 8-12 may generally include similar features as the centerplate 200 of FIGS. 1-7 including but not limited to centerplate rails 404a, 404b, and a plurality of rings 416 disposed concentrically around a center point 424, the rings 416 connected by stems 428, and the rings including notches 484. Thus, discussion of centerplate 200 above also generally applies to similarly numbered or named components of the centerplate 400 (and vice versa).

In some embodiments, a length of the centerplate 400 measured parallel to the centerplate rails 404a, 404b, may be different than a length of the centerplate 200 measured parallel to the centerplate rails 204a, 204b. For example, the centerplate 200 may be larger, configured to be secured between the building structures 112, 116 (as shown in FIG. 1) that are spaced farther apart. In some embodiments, the length of the centerplate 200 along a longest edge of the centerplate 200 may be about 12.4″ while the length of the centerplate 400 along a longest edge of the centerplate 400 may be about 11.4″.

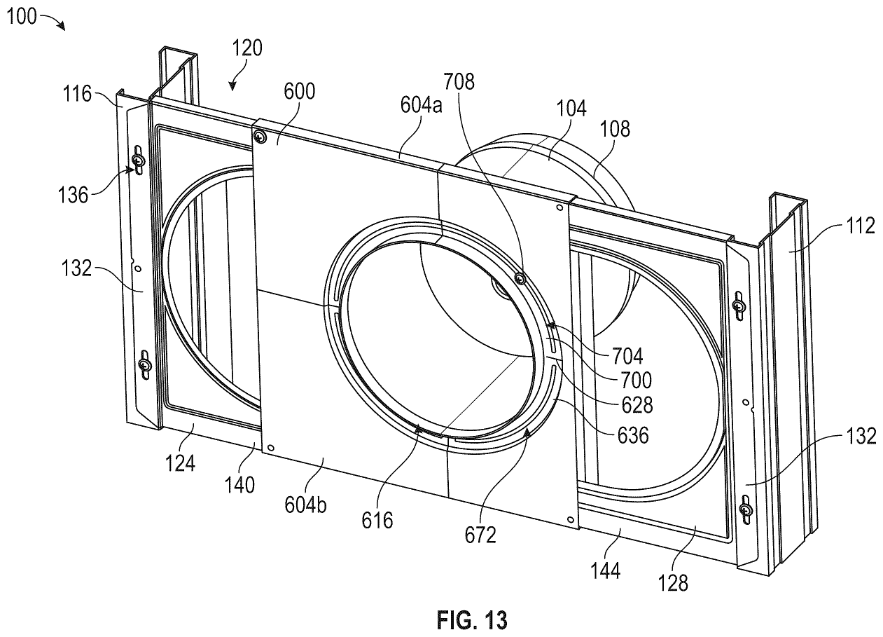

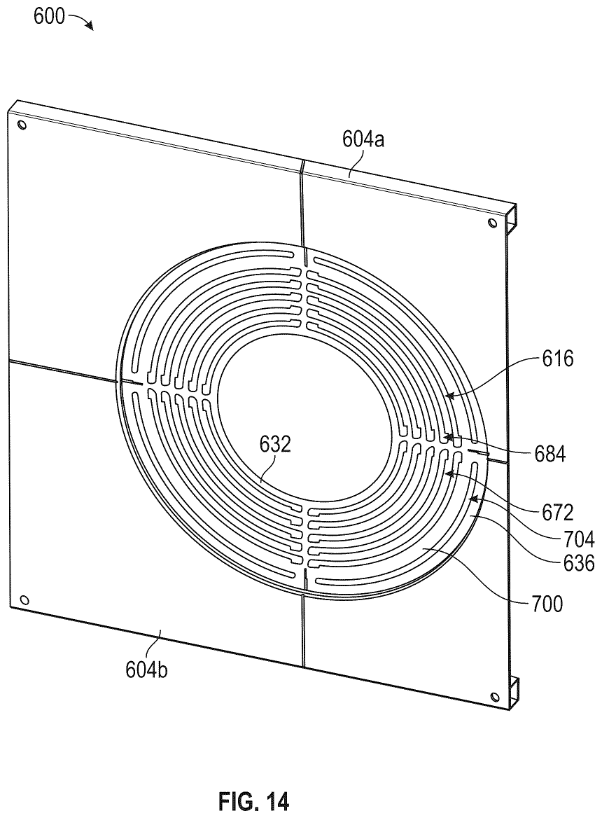

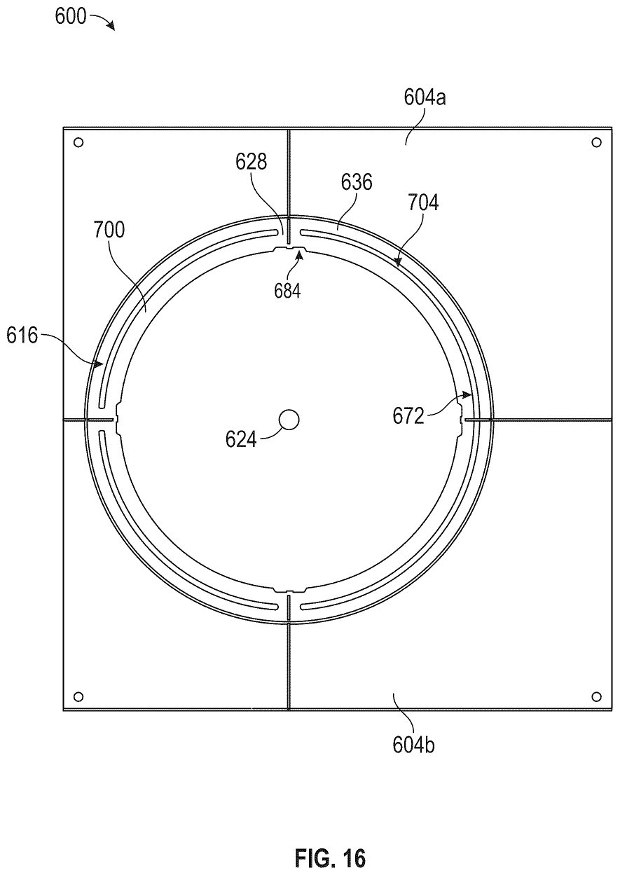

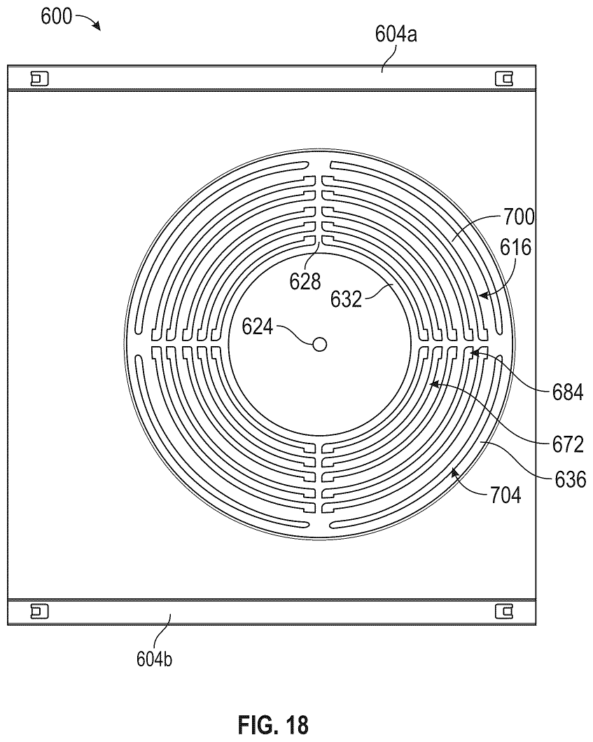

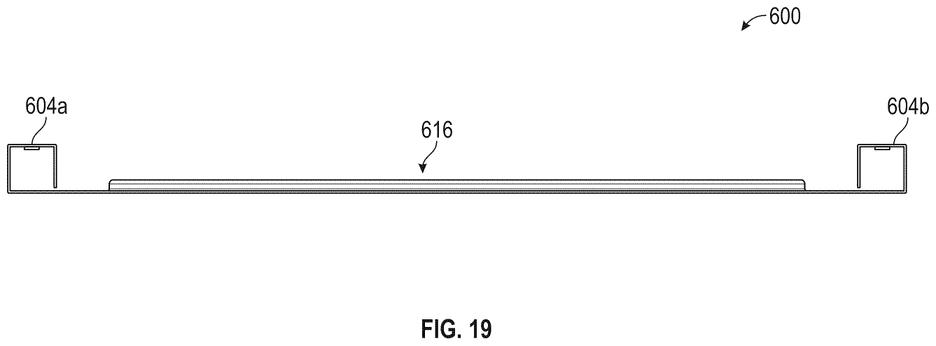

In some embodiments, a centerplate may include a perimeter gap that does not include notches. In this regard, for example, FIGS. 13-19 illustrate another embodiment of a centerplate 600. The centerplate 600 of FIGS. 13-19 may generally include similar features as the centerplate 200 of FIGS. 1-7 and centerplate 400 of FIGS. 8-12 including but not limited to centerplate rails 604a, 604b, and a plurality of rings 616 disposed concentrically around a center point 624, the rings 616 separated by gaps 672 and connected by stems 628, and one or more of the rings including notches 684. Thus, discussion of centerplates 200, 400 above also generally applies to similarly numbered or named components of the centerplate 600 (and vice versa).

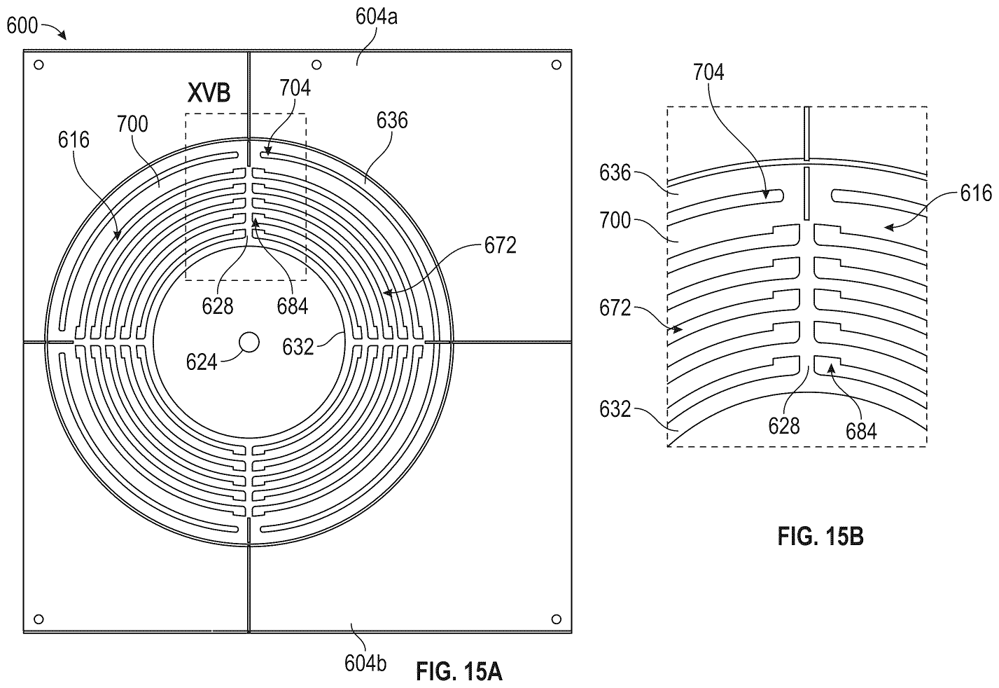

As described above, referring to FIGS. 15A and 15B, each of the rings 616 may define a unique inner radius, and a unique outer radius that is larger than the inner radius measured along a radial direction extending radially from the center point 624 of the rings 616. As illustrated in FIG. 15A, the plurality of rings 616 may include five removable rings and two non-removable perimeter rings. However, the centerplate 600 may include more or fewer rings having any radius to mount and receive equipment of any size.

Still referring to FIG. 15A, the rings 616 may include a first ring 632 (e.g., an inner-most ring), a perimeter ring 636 (e.g., an outermost ring), and a plurality of the rings 616 disposed between the first ring 632 and the perimeter ring 636. Furthermore, the rings 616 can include a sixth ring 700 that is connected to the perimeter ring 636 by the stems 628. The sixth ring 700 can define a diameter that is larger than the first ring 632 and smaller than the perimeter ring 636. Furthermore, the diameter defined by the sixth ring 700 may be larger than the plurality of the rings 616 disposed between the first ring 632 and the sixth ring 700. Furthermore, in some examples, the sixth ring 700 may define a radial thickness measured parallel to the radial direction, that may be greater than a radial thickness of the other rings 616.

In some examples, one or more of the rings 616 may not be removable from the centerplate 600. As described above, successive rings (e.g., an inner ring and an outer ring) of the plurality of rings 616 can be connected by one or more of the stems 628 extending from an outer diameter of the inner ring across a gap of the gaps 672 to an inner diameter of the outer ring. In some examples, the outer ring of the successive rings may not include the notches 684 extending into the inner diameter of the outer ring that locally enlarge the gap between the inner ring and the outer ring adjacent to the stems 628. In such examples, the stems 628 connecting the inner ring and the outer ring of the successive rings may not be severable, and the inner ring may therefore not be removable from the outer ring.

As an illustrative example, as illustrated in FIGS. 15A and 15B, a second gap 704 of the gaps 672 that extends circumferentially around the center point 624 may separate the perimeter ring 636 from the sixth ring 700. Furthermore, the perimeter ring 636 may not include the notches 684 that locally enlarge the second gap 704 adjacent to the stems 628 connecting the perimeter ring 636 and the sixth ring 700. As such, the sixth ring 700 may not be removable from the perimeter ring 636, because the stems 628 connecting the perimeter ring 636 and the sixth ring 700 may not be severable. Furthermore, the sixth ring 700 may define an outermost ring of the removable rings of the rings 616.

In some examples, as illustrated in FIGS. 15A and 15B, the stems 628 connecting the sixth ring 700 and the perimeter ring 636 may be wider, measured substantially perpendicular to a radial direction extending from the center point 624, than the stems 628 connecting the other rings 616. For example, the stems 628 connecting the sixth ring 700 and the perimeter ring 636 may be at least about 1.5 times wider, at least about 2 times wider, or at least about 3 times wider than the stems 628 connecting the other rings 616.

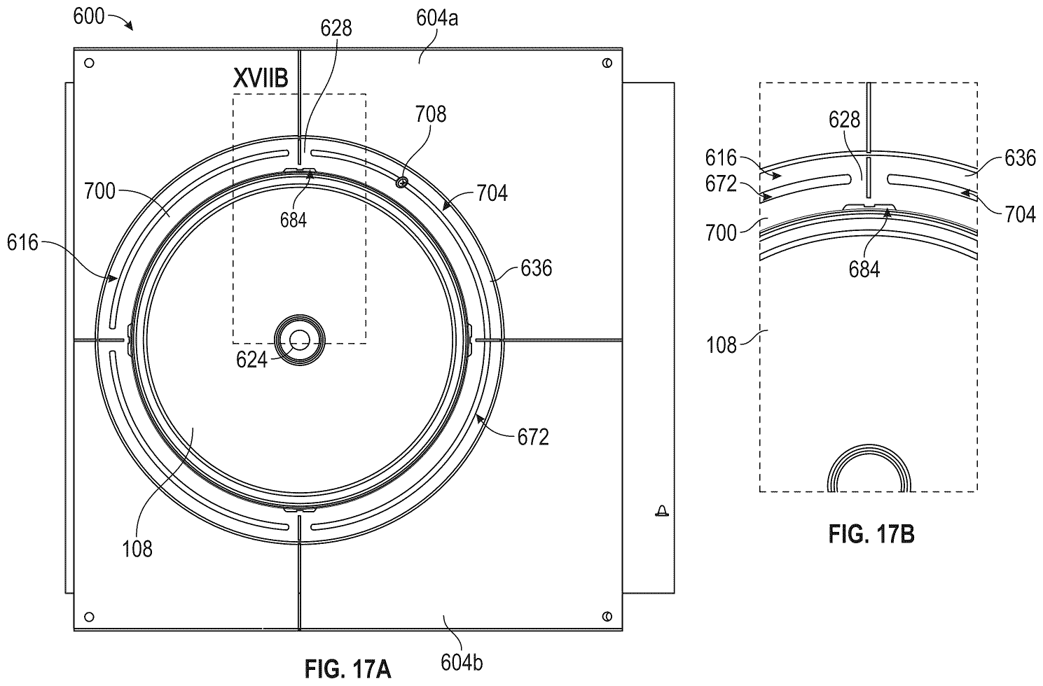

Referring to FIGS. 13 and 17A, as described above, one or more fasteners may secure the secure the equipment 108 to the centerplate 600. Specifically, fasteners 708 may extend through the gaps 672 formed between adjacent rings of the plurality of rings 616. The gaps 672 may provide pre-formed locations for insertion of the fasteners 708, which may simplify the installation process and reduce installation time of the equipment 108 onto the centerplate 600.

In some examples, the second gap 704 defined between the sixth ring 700 and the perimeter ring 636 may permanently be available to receive fasteners 708 for securing the equipment 108 to the centerplate 600. More specifically, as the sixth ring 700 may not be removable from the centerplate 600, the second gap 704 defined between the sixth ring 700 and the perimeter ring 636 may be permanent. As such, regardless of the number of the rings 616 (e.g., the removable rings) that are removed from the centerplate 600, the second gap 704 may be available to receive the fasteners 708 to secure the equipment 108 to the centerplate 600. As an illustrative example, the equipment 108 received in the equipment opening 220 defined by an inner diameter of the sixth ring 700 can be secured to the centerplate 600 by fasteners that extend through the second gap 704. This may advantageously simplify installation of the equipment 108 onto the centerplate 600 by providing the ability to extend the fasteners 708 through the gaps 672, instead of requiring the installer to drill the fasteners 708 through the centerplate 600.

In some examples, the centerplate 600 may include more of the rings 616 than the centerplates 200, 400. As such, the rings 616 may define a larger diameter than the rings 216, 416 of the centerplates 200, 400. Furthermore, a width of the centerplate 600 measured substantially parallel to the adjustment direction may be larger than a width of the centerplates 200, 400. Additionally, a height of the centerplate 600 measured substantially perpendicular to the adjustment direction may be larger than a height of the centerplates 200, 400.

Furthermore, as illustrated in FIG. 13, the bracket members 124, 128 of the support assembly may include a bracket embossment to provide rigidity to the support assembly 100.

Thus, examples of the disclosed technology can provide improved systems for telescopically supporting electrical equipment between building structures including assemblies with lighting assemblies, or electrical devices of various kinds, including electrical boxes, light fixtures (e.g., luminaires), fans, low voltage devices (e.g., outlets, switches, and other low voltage devices), and any other electrical device that can be mounted on a building structure. Some examples provide a support assembly that is inexpensive to manufacture while providing an improved mechanism for telescopically adjusting an extension length of a support assembly during installation.

As used herein, unless otherwise limited or specified, “substantially identical” or “substantially similar” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive.

Unless otherwise limited or defined, “substantially radial” indicates a direction that is within ±12 degrees of a reference direction (e.g., within ±6 degrees or ±3 degrees), inclusive. Likewise, unless otherwise limited or defined, “substantially tangential” indicates a direction that is within ±12 degrees of a reference direction (e.g., within ±6 degrees or ±3 degrees), inclusive.

Also as used herein, the use of “including,” “comprising,” or “having” and variations thereof is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise limited or defined, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive.

Also as used herein, unless otherwise limited or defined, “substantially identical” indicates that features or components are manufactured using the same processes according to the same design and the same specifications. In some cases, substantially identical features can be geometrically congruent.

Also as used herein, unless otherwise limited or defined, “substantially centered” indicates that a center of a feature or component relative to a reference direction is within 10% of center of another feature or component relative to the reference direction. For example, for a body having a length L relative to a first direction, a feature that is substantially centered on the body along a first direction has a center that is located at a distance of within 0.1*L of a midpoint of the body along the first direction. In contrast, unless otherwise limited or defined, “offset” indicates that a center of a feature or component is not substantially centered on another component.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “same” and derivatives thereof, in reference to comparing distances (e.g., widths, lengths, distances, or other known measures between two objects or two points), indicates that two or more distances being compared vary with respect to one another by less than 5%, or less than 10%, or less than 20%, inclusive.

Also as user herein, unless otherwise limited or defined “substantially rectangular” indicates a four sided polygon connected at four corners, each corner can define an angle between 80 degrees and 100 degrees, inclusive. Additionally, the corners of the four-sided polygon can be rounded, pointed, or can define any other relevant geometry.

Also as used herein, unless otherwise limited or defined, “substantially linear” indicates a line segment that is linear or is non-linear but with an average radius of curvature greater than 3 inches (e.g., greater than 4 inches, greater than 6 inches, greater than 12 inches, greater than 18 inches, greater than 25 inches, greater than 50 inches, greater than 100 inches, etc.).

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A centerplate for a lighting assembly, the centerplate comprising:
a support portion; and
a plurality of rings, integrally formed with the support portion, each ring of the plurality of rings being selectively removable to define a respective different size of opening in the support portion to receive the lighting assembly;
the plurality of rings including a first ring that defines a first inner radius corresponding to a first size of opening in the support portion, and a second ring that defines a second inner radius corresponding to a second size of opening in the support portion, the second inner radius being larger than the first inner radius;
the second ring including a notch that extends radially outward to define a notch inner radius on the second ring that is greater than the second inner radius; and
a stem extending between the first ring and the second ring to connect the first ring to the second ring,
the stem having a minimum stem width within the notch, as measured perpendicularly to a radial direction along the stem, that defines a cutting location within the notch to separate the first ring from the centerplate.

2. The centerplate of claim 1, wherein an outer perimeter of the plurality of rings is extruded relative to the support portion.

3. The centerplate of claim 1, wherein the support portion includes a plurality of rails configured to slidably engage a support bracket to slidably support the centerplate with the support bracket relative to a building structure.

4. The centerplate of claim 1, wherein the plurality of rings is arranged asymmetrically on the centerplate.

5. The centerplate of claim 4, wherein the support portion defines an adjustment direction of the centerplate relative to building support structure; and
wherein a center point of the plurality of rings is offset relative to a center of the centerplate along the adjustment direction.

6. The centerplate of claim 5, wherein the center point of the plurality of rings is centered on the centerplate along a direction perpendicular to the adjustment direction.

7. The centerplate of claim 1, wherein the notch defines flattened notch edges extending along the second inner radius on opposite sides of the stem.

8. The centerplate of claim 1, wherein, with the stem cut at the minimum stem width within first notch, a cut end of the stem that remains connected to the second ring does not extend past the second inner radius.

9. The centerplate of claim 1, wherein the notch has a maximum extension into the second ring adjacent to the stem.

10. The centerplate of claim 1, wherein the first ring defines a first outer radius that is separated from the second inner radius by one or more gaps in the centerplate; and
wherein the one or more gaps extend outward past the second inner radius on opposing sides of the stem to define the notch, and do not extend inward past the first outer radius adjacent the stem.

11. The centerplate of claim 1, wherein the notch defines a substantially rectangular shape.

12. The centerplate of claim 11, wherein the notch does not extend into the first ring.

13. The centerplate of claim 1, wherein a circumferential slot extends around an outermost ring of the plurality of rings, the circumferential slot configured to receive a fastener of the lighting assembly to secure the lighting assembly within the outermost ring.

14. A centerplate for a lighting assembly, the centerplate comprising:
a plurality of rings that are selectively removable to define different size openings for the lighting assembly;
a first ring of the plurality of rings defining a first inner radius;
a second ring of the plurality of rings defining a second inner radius that is greater than the first inner radius, with a notch extending radially outwardly into the second ring to receive a cutting tool; and
a stem that extends from a connection with the first ring at the first radius to a cuttable portion of the stem within the notch, to connect the first ring to the second ring.

15. The centerplate of claim 14, wherein the cuttable portion of the stem is a narrowest portion of the stem.

16. The centerplate of claim 15, wherein the notch defines a flattened edge adjacent to the stem within the notch.

17. A method for installing a lighting assembly, the method comprising:
providing a centerplate including a plurality of rings that are selectively removable to define different size openings for the lighting assembly, including a first ring that defines a first inner radius and a second ring that defines a second inner radius and is connected to the first ring by a stem;
selectively removing the first ring from the centerplate by inserting a cutting tool into a notch that extends radially outwardly into the second ring, and cutting a cuttable portion of the stem within the notch.

18. The method of claim 17, wherein a cut end of the stem that remains connected to the second ring does not extend inward past the second inner radius.

19. The method of claim 17, further comprising: after aligning the lighting assembly within the second ring, securing the lighting assembly to the centerplate by extending a fastener of the lighting assembly through a circumferential slot of the centerplate that extends around the second ring.

20. The method of claim 17, wherein the notch defines a substantially rectangular shape that receives the cutting tool to align the cutting tool with the cuttable portion of the stem.
